(19) United States
(12) Patent Application Publication
(10) Pub. No.: US 2004/0000587 A1
(43) Pub. Date: Jan. 1, 2004

(54) Electronic balloting module and electronic balloting method

(76) Inventor: Koichi Shibata, Chiba-shi (JP)

Correspondence Address: ADAMS & WILKS, 31st Floor, 50 Broadway, New York, NY, 10004, US

(21) Appl. No.: 10/463,719

(22) Filed: Jun. 17, 2003

(30) Foreign Application Priority Data
Jun. 18, 2002 (JP) 2002-177092

(51) Int. Cl. G06F 17/60

(52) U.S. Cl. 235/386

(57) ABSTRACT

Though simple in construction, an electronic balloting module and an electronic balloting method according to the invention can prevent disguise and negation, can eliminate a time difference resulting from an area difference and can also prevent tampering of an electronic balloting content. The electronic balloting module includes an interface 11 connected to an electronic equipment terminal for conducting electronic balloting through a network, a timepiece for generating time information, a storage unit and an operation unit each having a tamper-resistant structure, time calibration means connected to a predetermined time supervisory center through the electronic equipment terminal at least when the calibration means is operated, subjected to time calibration by the quartz timepiece and receiving a time supervision certificate, and time stamp means for acquiring time information of the time as electronic balloting time information from the quartz timepiece and outputting. an electronic certificate obtained by affixing a signature to the electronic balloting information and the electronic balloting time information by a secrete key of a predetermined public key cipher system with the time supervision certificate to the electronic balloting means provided that the time stamp means receives electronic balloting data from the electronic balloting means of the electronic equipment terminal or electronic balloting information comprising a unidirectional function value of the electronic balloting data.

### BACKGROUND OF THE INVENTION

1. Field of the Invention

This invention relates to an electronic balloting module and an electronic balloting method using the module that will be useful for conducting electronic balloting such as an auction on a network;, bidding and entry having a time limit, and so forth.

2. Description of the Related Art

A variety of electronic balloting such as an auction on a network, bidding and entry having a time limit, etc, have been carried out generally for predetermined members. To conduct appropriate electronic balloting, however, it is necessary to prevent disguise of members, negation, tampering, and so forth.

When an on-line auction is held, it has been necessary in the past to employ broadcast communication using satellite communication for distributing information on auction articles and to accept bidding to the auction through member terminals connected through a telephone line.

When an entry is made through the line, expensive equipment having a high capacity and a high processing speed must be prepared on the reception side in view of maximum transaction.

However, the method described above involves the problem that each member must prepare expensive equipment. Another problem left unsolved is that even when such a dedicated terminal is prepared, the method cannot prevent disguise and negation of the members. There is also the possibility that tampering of an entry to the auction exists.

Further, the most critical problem is that the method is not fair because a time difference of dozens of milliseconds occurs due to a difference of a communication distance between a server for accepting the entry of the auction and the member. Because the member that makes a bid faster can acquire the bidding right at the same bidding price, the time difference is a critical problem.

Besides bidding described above, the time difference also occurs depending on an area difference in electronic balloting having a time limit, and a management time of the server may be tampered.

### SUMMARY OF THE INVENTION

In view of the problems described above, it is an object of the invention to provide an electronic balloting module and an electronic balloting method that can prevent disguise and negation, can eliminate a time difference resulting from an area difference and can also prevent tampering of an electronic balloting content.

According to a first aspect of the invention, there. is provided an electronic balloting module comprising an interface connected to an electronic equipment terminal for conducting electronic balloting through a network, a quartz timepiece for generating time information, a storage unit having a tamper-resistant structure, an operation unit, time calibration means connected to a predetermined time supervisory center through the electronic equipment terminal at least when the time calibration means is operated, subjected to time calibration by the quartz timepiece and receiving a time supervision certificate, and time stamp means for acquiring time information of the time as electronic balloting time information from the quartz timepiece and outputting an electronic certificate obtained by affixing a signature to the electronic balloting information and the electronic balloting time information by a secrete key of a predetermined public key cipher system with the time supervision certificate to the electronic balloting means provided that the time stamp means receives electronic balloting data from the electronic balloting means of the electronic equipment terminal or electronic balloting information comprising a unidirectional function value of the electronic balloting data.

In the first aspect described above, a second aspect of the invention provides an electronic balloting module wherein the interface can be connected to various external connection interfaces of computers.

In the first or second aspect, a third aspect of the invention provides an electronic balloting module wherein the time calibration means establishes connection with the time supervisory center through predetermined ciphered communication.

In any of the first to third aspects, a fourth aspect of the invention provides an electronic balloting module wherein the storage unit is detachable as an IC card, stores various information used by the time calibration means and by the time stamp means, and is re-writable.

In any of the first to fourth aspects, a fifth aspect of the invention provides an electronic balloting module which further comprises a GPS reception unit, and wherein the quartz timepiece has synchronization means for synchronizing timepiece source oscillation as a reference for counting the time with 1 Hz source oscillation received by the GPS reception unit.

In the fifth aspect, a sixth aspect of the invention provides an electronic balloting module wherein the synchronization means requests the time calibration means to conduct time calibration provided that the signal from the GPS reception unit is interrupted for a predetermined period of time.

In any of the first to sixth aspects, a seventh aspect of the invention provides an electronic balloting module wherein the quartz timepiece further includes a temperature sensor and temperature correction means for correcting timepiece source oscillation as a reference for counting time to a predetermined error range on the basis of the temperature measured by the temperature sensor.

In any of the first to seventh aspects, an eighth aspect of the invention provides an electronic balloting module wherein the electronic balloting module does not have a power source, and acquires necessary power through the interface.

In the eighth aspect, a ninth aspect of the invention provides an electronic balloting module wherein the time supervision certificate is erased when the power source is turned off.

A tenth aspect of the invention provides an electronic balloting method comprising the steps of using an electronic balloting module having an interface to be connected to an electronic equipment terminal for conducting electronic balloting through a network, a quartz timepiece for generating time information, a storage unit having a tamper-resistant structure and an operation unit; connecting the electronic balloting module to the electronic equipment terminal to establish connection from the electronic balloting module to a predetermined time supervisory center when the electronic balloting module is activated, subjecting the quartz timepiece to time calibration and receiving a time supervision certificate; transmitting electronic balloting data or electronic balloting information comprising a unidirectional function value of the electronic balloting data to the electronic balloting module when electronic balloting is made from the electronic equipment terminal to a predetermined electronic balloting site, acquiring time information of the time as electronic balloting time information from the quartz timepiece and an electronic certificate obtained by affixing a signature to the electronic balloting information and to the electronic balloting time information by a secrete key of a predetermined public key cipher system with the time supervision certificate, and transmitting the electronic certificate to the electronic balloting. site provided that the electronic balloting module receives the electronic balloting information; and causing the electronic balloting site to determine a content of electronic balloting and a time of electronic balloting on the basis of the electronic balloting information and the electronic balloting time information contained in the electronic certificate.

In the tenth aspect, an eleventh aspect of the invention provides an electronic balloting method, wherein the interface of the electronic balloting module can be connected to various external connection interfaces of computers.

In the tenth or eleventh aspect, a twelfth aspect of the invention provides an electronic balloting method, wherein the electronic balloting module establishes connection with the time supervisory center through predetermined ciphered communication.

In any of the tenth to twelfth aspects, a thirteenth aspect of the invention provides an electronic balloting method, wherein the storage unit of the electronic balloting module is detachable as an IC card, stores various information used for time calibration and time stamp, and is re-writable.

In any of the tenth to thirteenth aspects, a fourteenth aspect of the invention provides an electronic balloting method, wherein the electronic balloting module further comprises a GPS reception unit, and timepiece source oscillation as a reference for the quartz timepiece to count the time is synchronized with 1 Hz source oscillation received by the GPS reception unit.

In the fourteenth aspect, a fifteenth aspect of the invention provides an electronic balloting method, wherein time calibration is requested for the time supervisory center to conduct time calibration provided that the signal from the GPS reception unit is interrupted for a predetermined period of time.

In any of the tenth to fifteenth aspects, a sixteenth aspect of the invention provides an electronic balloting method, wherein the quartz timepiece corrects timepiece source oscillation as a reference for counting time to a predetermined error range on the basis of the temperature measured by a temperature sensor.

In any of the tenth to sixteenth aspects, a seventeenth aspect of the invention provides an electronic balloting method, wherein the electronic balloting module does not have a power source, and acquires necessary power through the interface.

In the seventeenth aspect, an eighteenth aspect of the invention provides an electronic balloting method, wherein the time supervision certificate is erased when the power source is turned off.

The invention provides an electronic balloting module and an electronic balloting method that can prevent disguise and negation, can eliminate a time difference resulting from an area difference and can also prevent tampering of an electronic balloting content though construction is simple.

### BRIEF DESCRIPTION OF THE DRAWINGS

FIG. 1 is a block diagram conceptually showing an electronic balloting module and an electronic balloting method using the module according to an embodiment of the invention;

FIG. 2 is a block diagram conceptually showing time calibration and time stamp procedures in the electronic balloting module according to the embodiment of the invention; and

FIG. 3 is a block diagram showing a time correction procedure in the electronic balloting module according to the embodiment of the invention.

### DESCRIPTION OF THE PREFERRED EMBODIMENT

A preferred embodiment of the invention will be explained in detail with reference to the accompanying drawings.

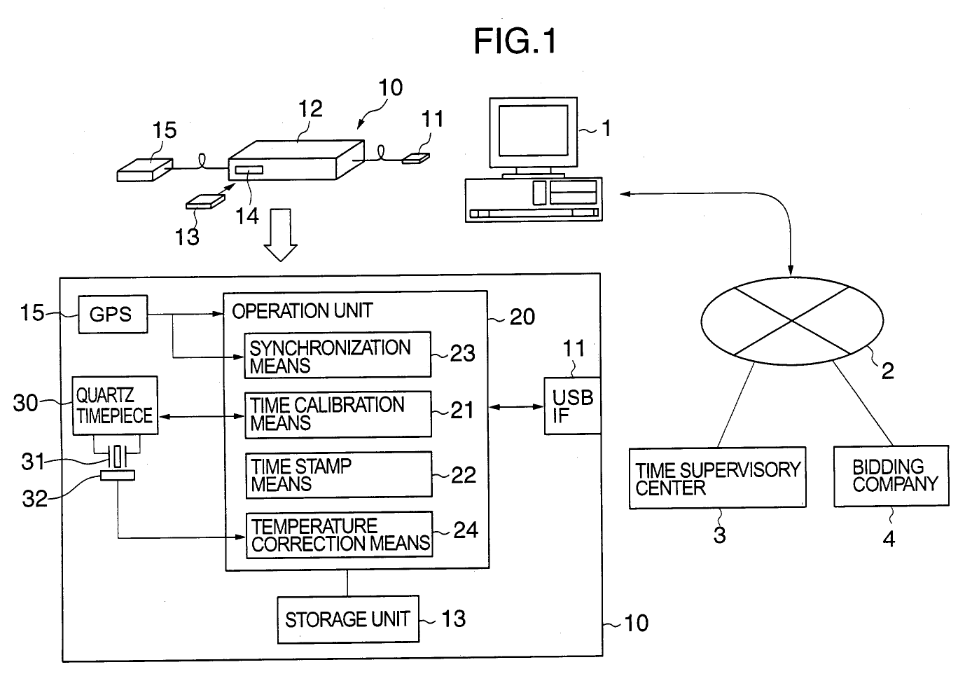

FIG. 1 conceptually shows an electronic balloting module and an electronic balloting method using the module according to an embodiment of the invention. As shown in FIG. 1., the electronic balloting module 10 is a module that includes an interface 11 and can be used while connected to a USB port of a personal computer 1. A module main body 12 has a card port 14 into which a detachable storage unit 13 constituted by an IC card can be fitted. A Global Positioning System GPS reception unit 15 is connected to the module main body 12. Incidentally, the personal computer 1 can be connected to the Internet 2 or to a dedicated network through an ISDN, an ADSL, a CATV, a wireless LAN, or the like.

The interface 11 for connection with the personal computer 1 is not limited to the USB interface but may be other card slots such as a PC card, or a wireless interface such as an infrared ray port or Bluetooth. Furthermore, the interface 11 may be a standard interface such as a parallel port or a serial port. Needless to say, the connected party is not particularly limited so long as it is an electronic equipment terminal that can be connected to a time supervisory center 3 and to bidding company 4 through the Internet 2. Therefore, the connected party may be various mobile terminals such as Personal Digital Assistance PDA, or mobile terminals having a cellular telephone unit or a Personal Handyphone System PHS. In this case, the connected party may well have an interface corresponding to the respective connection port. Incidentally, the interface need not always be connected through a cable shown in the drawing.

The storage unit 13 is not limited to the IC card so long as it has a tamper-resistant structure that is detachable from the module main body 12 and can re-write the information stored. Here, the term “tamper-resistant structure” means a structure that can prevent physically and logically acquisition, tampering and the like of the internal information by illegal procedures from outside. Incidentally, the storage unit 13, described below in detail, stores an ID and a password or a cipher key necessary for establishing safe connection between the time supervisory center 3 and the bidder company 4 and a cipher key used for time stamping. When directly written and stored on the bidder company side at the time of contract with the bidding company 4, these ID, password or cipher key can exclude connection with parties other than those having the storage unit 13, and can also exclude disguise and negation of the members.

The GPS reception unit 15 is a unit that receives signals from a GPS (Global Positioning System) satellite. The GPS reception unit 15 transmits a high accuracy 1 Hz signal on the basis of time information and position information from a plurality of GPS satellites. In this embodiment, at least 1 Hz source oscillation transmitted from the GPS satellite may well be received. Incidentally, the GPS satellite itself transmits time information but this embodiment need not receive time information. Though this time information itself is accurate to a certain extent, an electronic certificate inclusive of a later-appearing time supervision certificate and stamped time-wise must be issued in order to evidence that the time information is accurate. Therefore, the accurate time information itself need not be acquired from the GPS satellite.

The GPS reception unit 15 need not always be connected to the module main body 12 through the cable, but may be unitarily incorporated in the module main body 12 or may be wireless-connected.

The module main body 12 of the electronic balloting module 10 includes an operation unit 20 comprising a one-chip microcomputer including the CPU, the ROM and the RAM, and a quartz timepiece 30. The quartz timepiece 30 includes quartz 31, and a temperature sensor 32 is disposed in the proximity of the quartz 31.

The operation unit 20 includes time calibration means 21, time stamp means 22, synchronization means 23 and temperature correction means 24. The time calibration means 21 is connected to the predetermined time supervisory center 3 at least at the time of activation through the personal computer 1 as the electronic equipment terminal and through the Internet 2, is subjected to time calibration by the quartz timepiece 30 and receives a time supervision certificate. The time stamp means 22 acquires time information of the time as electronic balloting time information from the quartz timepiece 30 under the condition that electronic balloting data or electronic balloting information as a unidirectional function value of the former from the electronic balloting means of the personal computer 1 is received, and outputs an electronic certificate generated by signing the electronic balloting information and the electronic balloting time information by a secrete key of a predetermined public key cipher system together with the time supervision certificate to the electronic balloting means. The synchronization means 23 synchronizes the 1 Hz source oscillation received by the GPS reception unit 15 with the timepiece source oscillation based on the oscillation of the quartz 31 of the quartz timepiece 30. The temperature correction means 24 corrects the timepiece source oscillation to fall within a predetermined error range on the basis of the temperature measured by the temperature sensor 32.

Incidentally, the electronic balloting module 10 according to this embodiment does not have a power source, but receive the supply of power and operates through the interface 11 when connected to the personal computer 1. Therefore, the quartz timepiece 30 does not have time information, either, under the non-connection state.

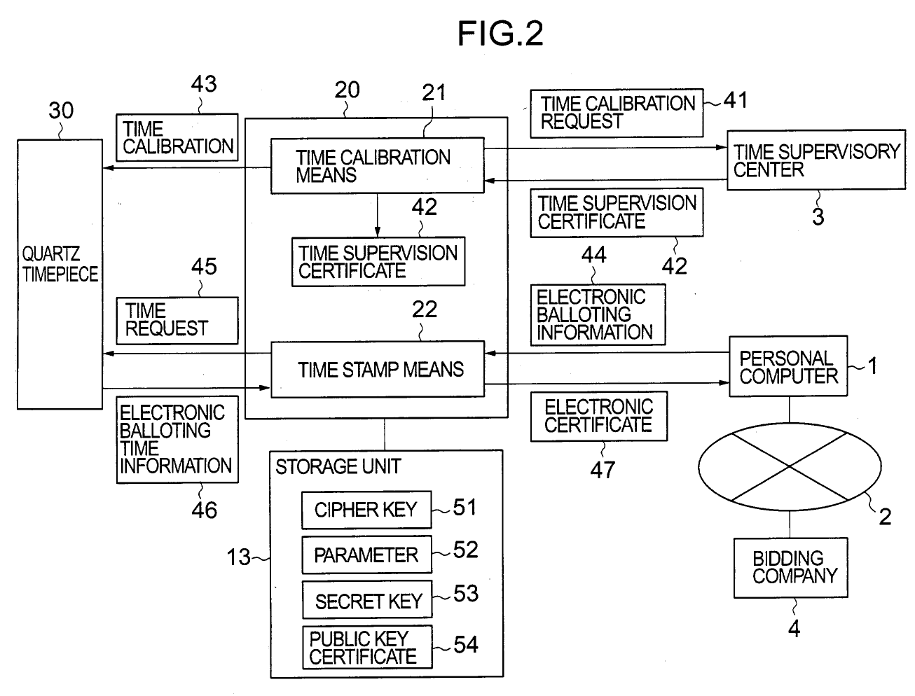

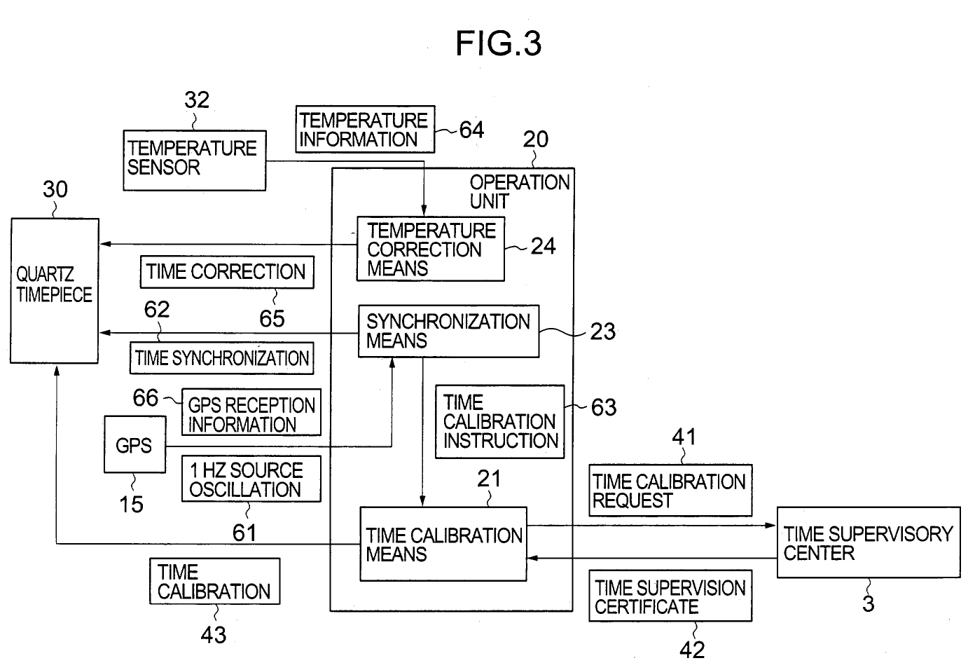

Hereinafter, a concrete construction of the electronic balloting module 10 and an example of the electronic balloting method using the module 10 will be explained in accordance with the procedure of the practical use with reference to FIGS. 2 and 3.

When the interface 11 of the electronic balloting module 10 is connected to the personal computer 1 as shown in FIG. 2, power is supplied to the electronic balloting module 10 and the time calibration means 21 of the operation unit 20 starts operating. When activated, the time calibration means 21 is connected to the time supervisory center 3 through the personal computer 1 and generates a time calibration request 41.

Here, connection between the time calibration means 21 and the time supervisory center 3 is established under the state where security is insured by a virtual private network (VPN), or the like, using the public key cipher system. The storage unit 13 stores in advance the cipher key 51 such as the secret key or the public key used for establishing the connection and the parameter 52 such as the ID. Incidentally, the connection form is not particularly limited so long as security is insured, and information corresponding to the connection form may well be stored in such a case in place of the cipher key 51 and the parameter 52.

Receiving the time calibration request 41, the time supervisory center 3 transmits the time information as well as the time supervision certificate 42. The time calibration means 21 executes time calibration 43 of the quartz timepiece 30 on the basis of the time information received and stores the time supervision certificate 42 in a predetermined region. When the time supervision certificate 42 is thus received and stored, the time stamp means 22 is now ready for conducting time stamping. Incidentally, the time supervision certificate 42 is not stored in the non-volatile memory of the storage unit 13 but into the region of the RAM, for example, of the operation unit 20 so that it is erased when the power source is turned off. Needless to say, the time supervision certificate 42 may also be stored in the non-volatile memory so that it is erased when the power source is turned off.

Here, the time supervisory center 3 is, for example, a third party organization that has a cesium atom clock cooperating with the Convention World Time, a master clock to which a time source is supplied from the cesium atom clock and a time distribution server to which the time is supplied from the master clock, and can distribute the time in synchronism with the Convention World Time. The time supervisory center 3 verifies the time supervision certificate 42, whenever necessary.

Next, the electronic balloting application in the personal computer 1 is activated and auction is made with predetermined bidding companies 4 to execute electronic balloting such as bidding. Then, the electronic balloting information 44 as the unidirectional function value of the electronic data representing that electronic balloting is made is not directly transmitted to the bidding company 4 but is transmitted to the time stamp means 22 of the electronic balloting module 10. Here, the unidirectional function value is called also a “hash value” or a “message digest” and is, for example, a pseudo-random number having a fixed length that is generated by the irreversible unidirectional function such as the hash function. The same unidirectional function value can be obtained from the same data but the original data cannot be reproduced from the unidirectional function value. Here, the unidirectional function value is transmitted to the electronic balloting module 10 but the unidirectional function value may well be generated inside the electronic balloting module 10. Alternatively, time stamp may be applied to the electronic balloting information that is not the unidirectional function value.

Acquiring the electronic balloting. information 44, the time stamp means 22 generates the time request 45 and acquires the electronic balloting time information 46 representing that electronic balloting is made. Here, the synchronization means 23 synchronizes the time information of the quartz timepiece 30 at each turning point of the second on the basis of the 1 Hz source oscillation received by the GPS reception unit 15 as described above, and the time calibration means 21 executes the time calibration. Therefore, this time information gives a correct time in the μsec order. The time information is the time that is subjected to the time calibration by the time supervisory center 3 as the third party and is free from illegality.

The time stamp means 22 affixes the electronic signature to at least the electronic balloting information 44 and the electronic balloting time information 46 by use of the secret key 53 for the time stamp to generate the electronic certificate 47, and transmits the electronic certificate 47 to the electronic balloting application of the personal computer 1.

The form of the electronic certificate 47 is not particularly limited so long as it is associated with the electronic balloting information 44 and with the electronic balloting time information 46 and exists under the state where it is not illegally tampered. For example, the electronic certificate 47 is preferably the one that is affixed with the electronic signature ciphered by use of the secrete key 53 stored in advance in the storage unit 13 having the tamper-resistant structure on the bidding company side 4 when registered to the bid company 4.

The electronic certificate 47 is allowed to contain also the time supervision certificate 42 that the time calibration means 21 acquires from the time supervisory center 3 in advance. Therefore, the electronic certificate 47 evidences that the electronic balloting time information 46 is acquired from the quartz timepiece 30 supervised by the third party. Incidentally, because the time supervision certificate 42 per se is under the state where it is not tampered, it may be merely attached, but is preferably under the state where it is ciphered and electronically signed in association with the electronic balloting information 44 and with the electronic balloting time information 46. Furthermore, the public key certificate 54 of the public key corresponding to the secret key 53 is preferably attached to the electronic certificate 47 because it is necessary for confirming the content of the electronic certificate 47. The secrete key 53 and the public key certificate 54 used by the time stamp means 22 are stored in advance in the storage unit 13.

The electronic balloting application of the personal computer 1 transmits the electronic certificate 47 so acquired to the bidding company 4 and completes electronic balloting. However, the time of electronic balloting is judged from the time of the electronic balloting time information 46 acquired from the quartz timepiece 30 of the electronic balloting module 10. Therefore, the time of electronic balloting can be correctly acquired in the μsec order irrespective of the distance from the personal computer 1 to the bidding company 4, i.e., irrespective of the area difference.

The quartz timepiece 30 counts the time with accuracy of the quartz 31, that is, about ±5 ppm, for example, and can secure sufficient accuracy. When higher accuracy is not necessary, time correction by the later-appearing GPS reception unit 15 and synchronization means 23 and time correction by the temperature correction means 24 are not always necessary. Needless to say, it is preferred in this case, too, that time calibration 43 by the time calibration means 21 described above is made in a predetermined cycle and the time supervision certificate 42 is updated at each time. However, access in the number of times more than necessary is not preferred in view of the load to the time supervisory center 3. For this reason, this embodiment improves accuracy of time information generated by the quartz timepiece 30 by use of the following construction.

The electronic balloting module 10 according to this embodiment has the GPS reception unit 15 and the synchronization means 23 and synchronizes the time source oscillation of the time counted by the quartz timepiece 30 with the signal acquired from the GPS reception unit. This procedure will be explained with reference to FIG. 3.

The synchronization means 23 acquires the 1 Hz source oscillation 61, that is, a pulse per second, from the GPS reception unit 15 and conducts time synchronization 62 of the quartz timepiece 30 on the basis of the pulse. The quartz timepiece 30 counts the time on the basis of the timepiece source oscillation from the quartz 31 such as a 32 KHz source oscillation. This source oscillation involves an error of about ±5 ppm, but time correction is made every second by synchronizing the time source oscillation with the 1 Hz source oscillation described above.

Because of the construction described above, the quartz timepiece 30 counts the time that is in synchronism with the Convention World Time. However, the GPS reception unit 15 must receive the signal from the GPS satellite. In this embodiment, the GPS reception unit 15 transmits the GPS reception information 66 as the signal representing the reception condition of the GPS satellite to the synchronization means 23. When the synchronization means 23 cannot receive the information from the GPS satellite f or a predetermined time from the GPS reception unit 15, it generates the time calibration instruction 63 to the time calibration means 21, and the time calibration means 21 conducts time calibration in accordance with the procedure described above. In other word, the time calibration means 21 connects to the time supervisory center 3, generates the time calibration request 41, receives the time information from the time supervisory center 3, conducts time calibration 43, acquires the time supervision certificate 42 and updates the time supervision certificate 42 stored in the predetermined region. When the time stamp means 22 uses the latest time supervision certificate 42, it is of course possible to store the latest time supervision certificate 42 without updating it. The time synchronized with the Convention World Time can thus be secured.

The period from the time at which the GPS reception unit 15 becomes unable to receive the 1 Hz source oscillation 61 from the GPS satellite to the time at which the time calibration instruction 63 is given to the time calibration means 21 is decided depending on which time accuracy is to be secured. Assuming that the timepiece source oscillation from the quartz 31 has an error of about ±5 ppm, for example, the error becomes 18 μsec maximum when the time calibration instruction 63 is executed at one hour and becomes 14 μsec maximum when the time calibration instruction 63 is executed at 45 minutes.

The timepiece source oscillation of the quartz 31 varies with the ambient temperature. Therefore, to obtain accuracy within the range of ±5 ppm, for example, temperature correction must be conducted. In this embodiment, the temperature sensor 32 for measuring the ambient. temperature of the quartz 31 and the temperature correction means 24 execute temperature correction.

In other words, the temperature correction means 24 acquires the temperature information 64 from the temperature sensor 32 and based thereon executes time correction 65 for correcting the timepiece source oscillation described above. Time correction may be conducted in a customary manner on the basis of a correction table, for example.

Needless to say, this embodiment may well have the temperature correction means 24 instead of having the GPS reception unit 15 and the synchronization means 23.

When the electronic balloting module 10 and electronic balloting using the module 10 are executed, the time difference based on the area difference can be eliminated and tampering of the balloting content can be prevented in electronic balloting such as an auction. When the electronic balloting modules 10 are distributed to the members and the information necessary for gaining access is stored in advance in the storage unit 13 to permit the access, disguise and negation of the members can be prevented.

As explained above, the invention can provide the electronic balloting module and the electronic balloting method that do not require expensive setup that has been required in the past, can prevent disguise and negation through the simple setup, can eliminate the time difference resulting from the area difference and can prevent tampering of the electronic balloting content.

1. An electronic balloting module comprising:
an interface connected to an electronic equipment terminal for conducting electronic balloting through a network;
a timepiece to generate time information;
a storage unit and an operation unit each having a tamper-resistant structure;
time calibration means connected to a predetermined time supervisory center through said electronic equipment terminal at least when said calibration means is operated, subjected to time calibration by said quartz timepiece and receiving a time supervision certificate; and
time stamp for acquiring time information of the time as electronic balloting time information from said timepiece and outputting an electronic certificate obtained by affixing a signature to the electronic balloting information and the electronic balloting time information by a secrete key of a predetermined public key cipher system with said time supervision certificate to said electronic balloting means provided that said time stamp means receives electronic balloting data from said electronic balloting means of said electronic equipment terminal or electronic balloting information comprising a unidirectional function value of said electronic balloting data.

2. An electronic balloting module according to claim 1, wherein said interface can be connected to various external connection interfaces of computers.

3. An electronic balloting module according to claim 1, wherein said time calibration means establishes connection with said time supervisory center through predetermined ciphered communication.

4. An electronic balloting module according to claim 1, wherein said storage unit is detachable as an integrated circuit card, stores various information used by said time calibration means and by said time stamp means, and is re-writable.

5. An electronic balloting module according to claim 1, which further comprises a GPS reception unit, and wherein said timepiece has synchronization means for synchronizing timepiece source oscillation as a reference for counting the time with 1 Hz source oscillation received by said GPS reception unit.

6. An electronic balloting module according to claim 5, wherein said synchronization means requests said time calibration means to conduct time calibration provided that the signal from said GPS reception unit is interrupted for a predetermined period of time.

7. An electronic balloting module according to claim 1, wherein said timepiece further includes a temperature sensor and temperature correction means for correcting timepiece source oscillation as a reference for counting time to a predetermined error range on the basis of the temperature measured by said temperature sensor,

8. An electronic balloting module according to claim 1, wherein said electronic balloting module does not have a power source, and acquires necessary power through said interface.

9. An electronic balloting module according to claim 8, wherein said time supervision certificate is erased when the power source is turned off.

10. An electronic balloting method comprising the steps of:
using an electronic balloting module having an interface to be connected to an electronic equipment terminal for conducting electronic balloting through a network, a timepiece for generating time information and a storage unit and an operation unit each having a tamper-resistant structure;
connecting said electronic balloting module to said electronic equipment terminal to establish connection from said electronic balloting module to a predetermined time supervisory center when said electronic balloting module is activated, subjecting said quartz timepiece to time calibration and receiving a time supervision certificate;
transmitting electronic balloting data or electronic balloting information comprising a unidirectional function value of said electronic balloting data to said electronic balloting module when electronic balloting is made from said electronic equipment terminal to a predetermined electronic balloting site, acquiring time information of the time as electronic balloting time information from said timepiece and an electronic certificate obtained by affixing a signature to the electronic balloting information and to the electronic balloting time information by a secrete key of a predetermined public key cipher system with said time supervision certificate, and transmitting said electronic certificate to said electronic balloting site provided that said electronic balloting module receives the electronic balloting information; and
causing said electronic balloting site to determine a content of electronic balloting and a time of electronic balloting on the basis of the electronic balloting information and the electronic balloting time information contained in said electronic certificate.

11. An electronic balloting method according to claim 10, wherein said interface of said electronic balloting module can be connected to various external connection interfaces of computers.

12. An electronic balloting method according to claim 10, wherein said electronic balloting module establishes connection with said time supervisory center through predetermined ciphered communication.

13. An electronic balloting method according to claim 10, wherein said storage unit of said electronic balloting module is detachable as an integrated circuit card, stores various information used for time calibration and time stamp, and is re-writable.

14. An electronic balloting method according to claim 10, wherein said electronic balloting module further comprises a GPS reception unit, and timepiece source oscillation as a reference for said quartz timepiece to count the time is synchronized with 1 Hz source oscillation received by said GPS reception unit.

15. An electronic balloting method according to claim 14, wherein time calibration is requested for said time supervisory center to conduct time calibration provided that the signal from said GPS reception unit is interrupted for a predetermined period of time.

16. An electronic balloting method according to claim 10, wherein said quartz timepiece corrects timepiece source oscillation as a reference for counting time to a predetermined error range on the basis of the temperature measured by a temperature sensor.

17. An electronic balloting method according to claim 10, wherein said electronic balloting module does not have a power source, and acquires necessary power through said interface.

18. An electronic balloting method according to claim 17, wherein said time supervision certificate is erased when the power source is turned off.
